(19) United States
(12) Patent Application Publication
(10) Pub. No.: US 2009/0242752 A1
(43) Pub. Date: Oct. 1, 2009

(54) SAMPLE HOLDING DEVICE AND MASS SPECTROSCOPE AND MASS SPECTROSCOPIC METHOD USING THE SAMPLE HOLDING DEVICE

(75) Inventors: Naoki MURAKAMI, Ashigara-kami-gun (JP); Takeharu TANI, Ashigara-kami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/405,811

(22) Filed: Mar. 17, 2009

(30) Foreign Application Priority Data
Mar. 28, 2008 (JP) 2008-087352

(51) Int. Cl. B01D 59/44; H01J 49/00

(52) U.S. Cl. 250/282; 250/281

(57) ABSTRACT

A sample holding device used for a mass spectroscope includes a substrate on which a detection surface is formed, a measuring region formed on the detection surface of the substrate and having placed thereon at least an analyte, and a reference region formed in another region of the detection surface of the substrate except for the measuring region, the reference region having the same configuration as the measuring region except that the former does not have the analyte placed thereon.

The entire contents of documents cited in this specification are incorporated herein by reference.

### BACKGROUND

The present invention relates to a sample holding device used for detection of an analyte and a mass spectroscope and a mass spectroscopic method using the sample holding device.

Among mass spectroscopic methods used for the identification of an analyte or other like purposes is a mass spectrometry whereby an analyte is irradiated by light or an ion beam to ionize and desorb the analyte, thereupon detecting the desorbed analyte.

Among the methods of ionizing an analyte used in the mass spectroscopy are, for example, the MALDI (matrix-assisted laser desorption/ionization) method, the SALDI (surface-assisted laser desorption/ionization) method, the electron ionization method, the chemical ionization method, the fast atom bombardment ionization method, the electron spray ionization method, and the atmospheric pressure chemical ionization method.

Specifically, the MALDI method is a method whereby a sample prepared by mixing an analyte into a matrix (e.g., sinapic acid or glycerin) is irradiated by light to allow the matrix to absorb the energy of the light with which the sample was irradiated, the analyte is vaporized together with the matrix, and the proton transfer is allowed to take place between the matrix and the analyte, achieving ionization of the analyte.

The SALDI method is a method whereby no matrix is used and the surface of a substrate upon which a sample is placed is instead given functions similar to those of a matrix so that the analyte is ionized directly upon the surface of the substrate.

A sample plate (sample holding device) used for mass analysis employing the MALDI method is a stainless plate, for example.

JP 2007-502980 A describes a sample plate that is fabricated by applying a hydrophobic coating to the surface of an electrically conductive substrate, followed by coating with a mixed liquid of a matrix and a boundary polymer.

### SUMMARY OF THE INVENTION

Mass analysis of an analyte performed by detecting ions desorbed from the analyte is attended by a risk of detecting ions released from a substance other than the analyte of interest, making analysis of the analyte difficult.

The MALDI method, for example, presents a problem that an ionized matrix is detected whereas the SALDI method has a problem that ions derived from the substrate on which the analyte is placed are detected.

On the other hand, the sample unit described in JP 2007-592980 A poses a problem that the coating of the matrix certainly reduce the chances of the matrix being desorbed and ionized but still fail to totally eliminate the possibility of the matrix being ionized, thus allowing also the mass spectrum derived from a substance other than the analyte of interest.

In addition, the representations of the mass spectra of the analyte and a substance other than the analyte detected vary with the intensity of the laser light with which they are irradiated. Thus, accurate mass analysis of the analyte requires the elimination of the mass spectrum derived of the substance other than the analyte that varies with the intensity of the laser light.

Thus, an object of the present invention is to overcome the above problems associated with the prior art and provide a sample holding device having a simple configuration and capable of a high-accuracy mass analysis of an analyte, as well as a mass spectroscope and a mass spectroscopic method using that sample holding device.

A sample holding device according to the invention is one used for a mass spectroscope for irradiating a detection surface with light or ion beam to ionize an analyte sample placed upon the detection surface and desorb the analyte sample from the detection surface and detecting a mass/charge number of ion of the ionized analyte, the sample holding device comprising: a substrate on which the detection surface is formed, a measuring region that is formed on the detection surface of the substrate and on which at least an analyte is placed, and a reference region that is formed in another region of the detection surface of the substrate except for the measuring region, the reference region having a same configuration as the measuring region except that the reference region does not have the analyte placed thereon.

A mass spectroscope according to the invention comprises: the sample holding device of the invention having a measuring region and a reference region, radiating means for irradiating the sample holding device with light or ion beam, ion detecting means for detecting ions emitted from the measuring region of the sample holding device and ions emitted from the reference region of the sample holding device, mass spectrum calculating means for calculating a first mass spectrum according to detection results of the ions emitted from the measuring region and calculating a second mass spectrum according to detection results of the ions emitted from the reference region, mass spectrum correcting means for correcting the first mass spectrum according to the second mass spectrum calculated by the mass spectrum calculating means, and mass detecting means for detecting a mass/charge number of ion of the analyte according to a value corrected by the mass spectrum correcting means.

A mass spectroscopic method according to the invention comprises: a first mass spectrum detecting step of irradiating a measuring region of the mass spectrum device of the invention with light or ion beam to detect ions emitted from the measuring region and calculating a first mass spectrum from detection results, a second mass spectrum detecting step of irradiating a reference region of the mass spectrum device with light or ion beam to detect ions emitted from the reference region and calculating a second mass spectrum from detection results, a correcting step of correcting the first mass spectrum using the second mass spectrum, and a mass detecting step of detecting a mass/charge number of ion of the analyte according to correction results obtained in the correcting step.

### BRIEF DESCRIPTION OF THE DRAWINGS

Now, the inventive sample holding device as well as the mass spectroscope and the mass spectroscopic method using that device will be described referring to the accompanying drawings in which:

FIG. 1A is a front view illustrating a schematic configuration of a mass spectroscope using the inventive sample holding device;

FIG. 1B is a perspective view illustrating a schematic configuration of a part including a device moving means of the mass spectroscope illustrated in FIG. 1A.

FIG. 2 is a top plan view illustrating a schematic configuration of the sample holding device of FIG. 1.

FIGS. 3A to 3C are graphs each illustrating a mass spectrum obtained by measurement or calculation.

FIG. 4 is a top plan view illustrating a schematic configuration of another example of the inventive sample holding device.

FIG. 5 is a top plan view illustrating a schematic configuration of another example of the inventive sample holding device.

FIG. 6 is a top plan view illustrating a schematic configuration of another example of the inventive sample holding device.

FIG. 7 is a top plan view illustrating a schematic configuration of another example of the inventive sample holding device.

FIG. 8 is a top plan view illustrating a schematic configuration of another example of the inventive sample holding device.

FIG. 9 is a top plan view illustrating a schematic configuration of another example of the inventive sample holding device.

FIG. 10 is a perspective view illustrating a schematic configuration of an embodiment of a microstructure of the mass spectroscope illustrated in FIG. 1.

FIGS. 11A to 11C illustrate a process for producing a microstructure.

FIG. 12A is a sectional view illustrating a schematic configuration of a surface-modified microstructure; FIG. 12B is a sectional view illustrating a state where an analyte is desorbed from the microstructure illustrated in FIG. 12A.

FIG. 13A is a perspective view illustrating a schematic configuration of another example of microstructure; FIG. 13B is a partial top plan view of FIG. 13A.

FIG. 14 is a top plan view illustrating a schematic configuration of another example of microstructure.

FIG. 15A is a perspective view illustrating a schematic configuration of another example of microstructure; FIG. 15B is a sectional view of FIG. 15A.

### DESCRIPTION OF THE PREFERRED EMBODIMENTS

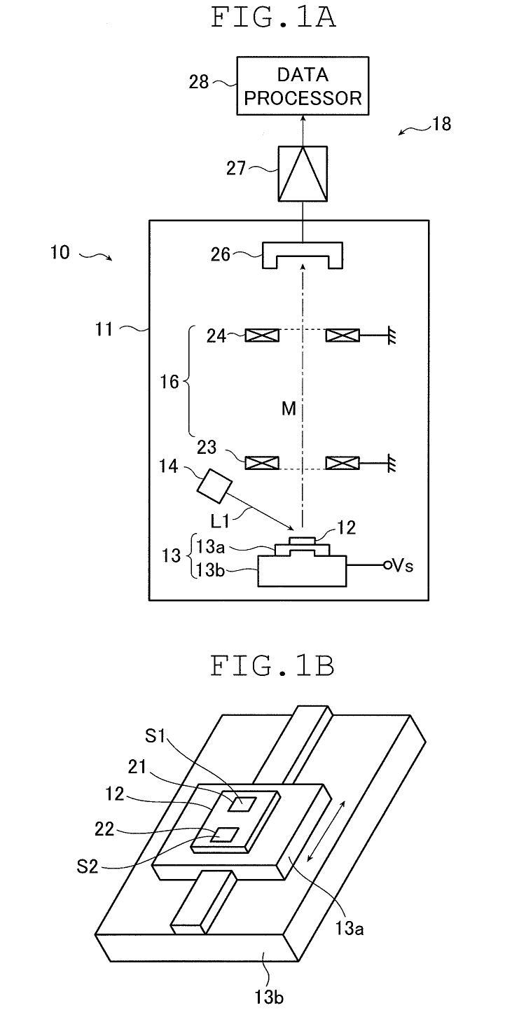

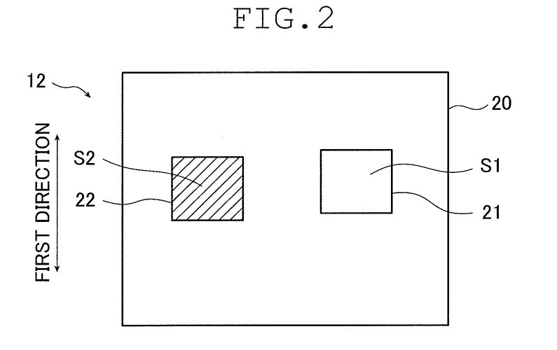

FIG. 1A is a front view illustrating a schematic configuration of a mass spectroscope using the inventive sample holding device; FIG. 1B is a perspective view illustrating a schematic configuration of a part including a device moving means of the mass spectroscope illustrated in FIG. 1A. FIG. 2 is a top plan view illustrating a schematic configuration of the sample holding device of FIG. 1.

As illustrated in FIG. 1A, a mass spectroscope 10 is a time-of-flight mass spectroscope (TOF-MS) whereby a substance desorbed from a sample holding device is allowed to fly a given distance and the mass (to be more exact, mass/charge number of ion) of that substance is analyzed according to the time of the flight. The mass spectroscope 10 comprises a box 11, a sample holding device (also referred to simply as “device” below) 12 disposed in the box 11 to place a sample containing an analyte M thereon, device moving means 13 for moving the device 12 in one direction, light radiating means 14 for irradiating the sample placed on the device 12 with measuring light L1 to desorb the analyte M in the sample from the device 12, flight direction control means 16 for allowing the desorbed analyte M to fly in a given direction, and mass analysis means 18 for detecting the desorbed analyte M to analyze the mass/charge number of ion of the analyte M.

The box 11 is a vacuum chamber in which a vacuum can be produced and is connected to a suction pump or other like means not shown. A vacuum is produced in the box 11 by sucking air with a suction pump from inside of the box 11 in a sealed state.

As illustrated in FIG. 2, the device 12 comprises a substrate 20 and a measuring region 21 and a reference region 22 formed on the surface of the substrate 20. The device 12 is disposed inside the box 11.

The substrate 20 is a sheet member.

The measuring region 21 is formed on a part of the surface of the substrate 20; a sample S1 containing mixed therein the analyte M and a matrix is placed on the surface of the measuring region 21.

The matrix is a compound that absorbs laser beam and stimulates the ionization of the sample (analyte M).

The reference region 22 is formed on the surface of the substrate 20 (to be exact, on the same surface on which the measuring region is formed) and spaced a given distance from the measuring region 21. The reference region 22 has placed thereon a sample S2, which is a same sample having the same composition as the sample S1 except that the sample S2 does not contain the analyte M, that is, the sample S2 is only composed of the matrix.

As illustrated in FIG. 1B, the device moving means 13 comprises a support 13a and a drive mechanism 13b. The support 13a supports the device 12 from the side thereof opposite from the side on which the measuring region 21 and the reference region 22 are formed. The drive mechanism 13b moves the support 13a in a given direction.

The drive mechanism 13b moves the support 13a in a direction parallel to a line connecting the measuring region 21 and the reference region 22 of the device 12 placed on the support 13a. Thus, the drive mechanism 13b moves the device 12 placed on the support 13a so that the measuring region 21 and the reference region 22 pass the same position. The device moving means 13 is connected to an electric power source to apply a given electric voltage from the device moving means 13 to the device 12.

The light radiating means 14 is a laser light source for irradiating the device 12 supported by the support 13a with light beam it emits. In this embodiment, the light radiating means 14 is adapted to irradiate a given fixed irradiation position so that the radiating means 14 irradiates a given region (the measuring region 21 or the reference region 22) of the device 12 as it is moved by the device moving device 13 to the irradiation position.

The flight direction control means 16 comprises an extraction grid 23 disposed between the device moving means 13 and the mass analysis means 18 and an end plate 24. The flight direction control means 16 applies a constant force to the analyte M desorbed from the device 12 to allow the analyte M to fly toward the mass analysis means 18. The extraction grid 23 is a hollow electrode so disposed between the device 12 and the mass analysis means 18 as to face the top surface of the device 12. The end plate 24 is a hollow electrode disposed between the extraction grid 23 and the mass analysis means 18. The extraction grid 23 and the end plate 24 are electrically grounded.

The flight direction control means 16 produces an electric field between the device 12 to which a given voltage is applied and the grounded extraction grid 23 to apply a constant force to the analyte M desorbed from the device 12, causing the analyte M to fly from the device 12 toward the extraction grid 23 at a given acceleration. Further, the flight path of the analyte M in flight is controlled by the extraction grid 23 and the end plate 24 so that the analyte M passes through the aperture or the hollow of the extraction grid 23 and then through the aperture or the hollow of the end plate 24, flying further on to the mass analysis means 18.

The mass analysis means 18 comprises a detector 26 for detecting the analyte M desorbed from the surface of the device 12 upon irradiation by the measuring light L1 and arriving at the detector 26 after flying through the apertures of the extraction grid 23 and the end plate 24, an amplifier 27 for amplifying the detection values given by the detector 26, and a data processor 28 for processing the output signal from the amplifier 27. The detector 26 is provided inside the box 11. The amplifier 27 and the data processor 28 are provided outside the box 11.

The mass analysis means 18 uses the data processor 28 to detect the mass spectrum of the analyte M according to the detection results given by the detector 26 and thereby detects the mass/charge number of ion (mass distribution) of the analyte M.

The mass spectroscope 10 basically has a configuration as described above.

Now, the mass spectroscopic method using the mass spectroscope 10 will be described.

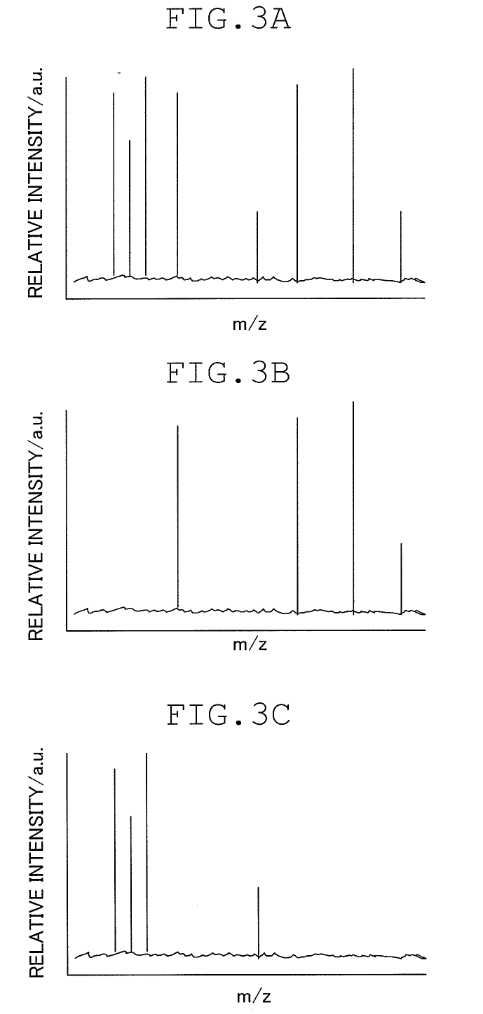

FIG. 3A is a graph illustrating a measurement of the mass spectrum of the sample S1 placed in the measuring region 21; FIG. 3B is a graph illustrating a measurement of the mass spectrum of the sample S2 placed in the reference region 22; and FIG. 3C is a graph illustrating the mass spectrum of the analyte calculated from the measurements illustrated in FIGS. 3A and 3B. FIGS. 3A to 3C indicate mass/charge number of ion (m/z value) on the horizontal axis and relative intensity in arbitrary unit [a.u.] on the vertical axis.

The sample S1 on the substrate 20, which contains mixed therein the analyte M and the matrix, is placed in the measuring region 21; the reference sample S2 consisting solely of the matrix is placed in the reference region 22.

Then, the device 12 now carrying the sample S1 and the reference sample S2 in the two regions, respectively, is placed on the support 13a of the device moving means 13.

Next, the drive mechanism 13b of the device moving means 13 moves the device 12 to locate the measuring region 21 at the position irradiated by the light emitted from the light radiating means 14.

Thereafter, a voltage Vs is applied to the device 12, whereupon the measuring light L1 is emitted from the light radiating means 14 in response to a given start signal so that the measuring region 21 of the device 12 is irradiated by the measuring light L1.

Upon irradiation by the measuring light L1, the optical energy of the radiated light is absorbed by the matrix of the sample S1 placed in the measuring region 21, causing the analyte M to vaporize together with the matrix. Further, proton transfer takes place between the matrix and the analyte M to ionize and desorb the analyte M.

The analyte M ionized and desorbed or the analyte M desorbed and ionized accelerates as it is drawn toward the extraction grid 23 by the electric potential difference Vs between the device 12 and the extraction grid 23. The analyte M then passes through the central aperture of the grid 23 and flies substantially straight in the direction of the end plate 24. The analyte M passes further on through the central aperture of the end plate 24, reaches the detector 26 and is thereby detected. The detector 26 detects the analyte M and the matrix because the ionized matrix also reaches the detector 26.

The flight speed of the analyte M after desorption depends upon the mass thereof when the initial speed and the number of charges are equal. Thus, the speed increases as the mass decreases so that the substance arrives at the detector 26 in the order of mass from smallest to greatest.

The output signal from the detector 26 is amplified by the amplifier 27 to a given level and then fed to the data processor 28.

The data processor 28 is fed with a synchronization signal in synchronism with the start signal mentioned earlier and calculates the time of flight of the detected substance according to the synchronization signal and the output signal from the amplifier 27.

The data processor 28 works out the mass/charge number of ion from the time of flight to obtain the mass spectrum (see FIG. 3A).

When the detection of the mass spectrum of the sample S1 is accomplished, the drive mechanism 13b of the device moving means 13 moves the device 12 to locate the reference region 22 at the position irradiated by the light emitted from the light radiating means 14.

Then, the reference region 22 is irradiated by the measuring light L1, as in the case where the sample S1 in the measuring region 21 is detected, to desorb the reference sample S2 in the reference region 22 (i.e., matrix). The reference sample S2 thus desorbed is detected by the detector 26 to calculate the mass spectrum of the reference sample S2 according to the relation between the detection result and the time of flight (see FIG. 3B).

Subsequently, the mass spectrum of the analyte M illustrated in FIG. 3C is calculated from the mass spectrum of the sample S5 illustrated in FIG. 3A and mass spectrum of the reference sample S2 illustrated in FIG. 3B.

Specifically, the mass spectrum of the analyte M illustrated in FIG. 3C is calculated by removing the mass spectrum of the reference sample S2 in the reference region 22, which has the same composition as the sample S1 except that the reference sample S2 does not contain the analyte M, from the mass spectrum of the sample S1 (i.e., by detecting the difference).

This is how the mass spectroscope 10 analyzes the mass/charge number of ion of the analyte M (or detects the mass distribution) Thus, according to the invention, the device 12 has the measuring region 21 that has placed on it the sample S1 containing the analyte M and the matrix and the reference region 22 that has placed on it the reference sample S2 having the same composition as the S1 except that the sample S2 does not contain the analyte M, and a mass spectrum is detected from each region to detect the difference. Thus, the mass spectrum attributable to the analyte M can be properly separated from the mass spectrum attributable to a substance other than the analyte M manner, thereby achieving analysis of the mass/charge number of ion of the analyte M with an increased accuracy.

Further, forming the measuring region 21 and the reference region 22 on the same substrate provides substantially the same conditions between them except for the presence of the analyte M. In addition, such a configuration permits a successive detection of mass spectra of two regions. Thus, virtually the same measuring conditions can be provided for the detection in the measuring region 21 and the reference region 22 so that mass spectra attributable to an identical substance can be detected without a variance, thereby achieving analysis of the mass/charge number of ion of the analyte M with an increased accuracy.

Further, the structure wherein the light radiating means 14 is fixedly provided and the device 12 is moved by the device moving means 13 provides substantially the same conditions under which the measuring light irradiates the measuring region 21 as it does the reference region 22 (e.g., incident angle and intensity), thereby achieving analysis of the mass/charge number of ion of the analyte M with an increased accuracy.

By a method using a matrix as in this embodiment, the mass spectrum attributable to the matrix can be removed, and even a low molecular analyte having a molecular mass close to that of the matrix can be readily detected.

Preferably, the mass spectroscope 10 so adjusts the position of the device 12 with the device moving means 13 as to detect mass spectra at a plurality of places in the measuring region 21 and mass spectra at a plurality of places in the reference region 22 of the device 12.

The detection of mass spectra at a plurality of places permits mass analysis of an analyte with an average of the detection results, thereby achieving analysis of the mass/charge number of ion of the analyte M with an increased accuracy.

Preferably, the device 12 has the measuring region 21 and the reference region 22 in a region where they have an identical coordinate in the direction (also referred to as a “first direction” below) normal to the direction in which the substrate 20 is rolled, injected or otherwise processed when manufactured. That is, the device 12 preferably has the measuring region 21 and the reference region 22 so that they share a straight line normal to the first direction (so that they lie on an identical straight line). In FIG. 2, the first direction is the upward and downward direction.

Forming the measuring region 21 and the reference region 22 so that they share a straight line normal to the first direction, along which straight line errors in properties, shape, and the like arising at the time of manufacture tend to be smaller, prevents mass spectra detected in both regions from varying according to the properties, shape, and the like of the sample holding device with an increased certainty.

More specifically, the sample holding device may possess variations in properties, shape, and the like on the surface of the substrate (in the measuring region and the reference region). Accordingly, variations may be produced in mass spectra obtained depending upon at which points in the measuring region and the reference region the spectra are detected.

Such variations in properties, shape, and the like in these regions of the substrate of the sample holding device often have a tendency: in the cases where, for example, the substrate is a thin aluminum film produced by rolling, the properties and the shape are substantially consistent in a given direction such as a direction in which the aluminum is rolled whereas the properties and the shape vary in the direction normal to the rolling direction.

Thus, when the measuring region lies in a given range in the first direction (i.e., in a given coordinate range) on the surface of the sample holding device, providing the reference region so that it also contains said given range in the first direction reduces the variations between a measuring position in the measuring region and a measuring position in the reference region and permits high-accuracy detection of the mass/charge number of ion of the analyte even though one sample holding device possesses variations in itself. Specifically, this is achieved, for example, by measuring the mass spectrum of the sample S1 at given coordinates in the measuring region and measuring the mass spectrum of the reference sample S2 in the reference region that is located at the same coordinate in the first direction as the one of said given coordinates in the first direction, followed by correcting the spectrum intensity of the mass spectrum measured from the measuring sample S1 in the measuring region with the spectrum intensity of the mass spectrum measured from the reference sample S2 in the reference region.

Now, description will be made in more detail below referring to specific examples.

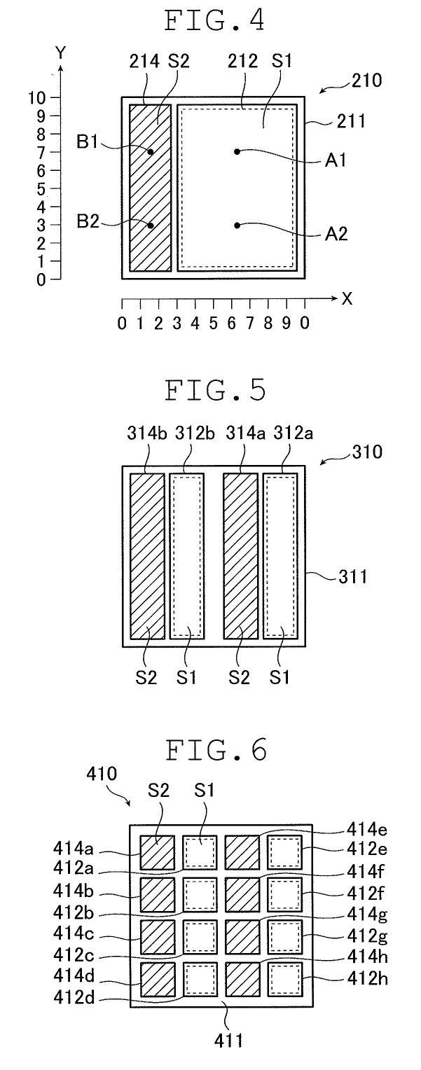

FIGS. 4, 5, and 6 are top plan views each illustrating schematic configurations of other examples of the inventive sample holding device.

As illustrated in FIG. 4, a sample holding device (also referred to simply as “device” below) 210 comprises a substrate 211, a measuring region 212 formed on the surface of the substrate 211 and carrying the sample S1 containing the analyte M and the matrix, and a reference region 214 carrying the reference sample S2 having the same composition as the sample S1 except for the absence of the analyte.

On the device 210, the measuring region 212 is formed in a given range in the first direction of the substrate 211, i.e., in the Y-axis direction in FIG. 4 (Y coordinate 0.5 to 9.5); the reference region 214 also is formed in a given range in the Y-axis direction (Y coordinate 0.5 to 9.5). The device 210 is fabricated by rolling the substrate 121 in a direction normal to the first direction (X-axis direction in FIG. 4).

Described below by way of example is an operation where a mass spectrum is measured from a point A1 (Y coordinate 7) in the measuring region 212 and a point A2 (Y coordinate 3) in the measuring region, 212 of FIG. 4 to detect the mass/charge number of ion of the analyte M. In this embodiment, the device moving means is an X-Y stage whereby the device 210 is placed on the support 13a and moved two-dimensionally in X and Y directions using the drive mechanism.

First, the drive mechanism moves the device 210 to locate the point A1 (Y coordinate 7) in the measuring region 212 at the position irradiated by the measuring light L1 emitted from the light radiating means 14.

Next, the measuring light L1 is radiated, and the mass spectrum of the sample S1 located at the point A1 is measured and stored in the data processor 28. Since the method of measuring the mass spectrum of a substance desorbed from the sample S1 is the same as described above, description thereof will not be given here. Likewise, description of the method of detecting mass spectra will also be omitted.

Then, the drive mechanism moves the device 210 to locate a point B1 (Y coordinate 7) in the reference region 214 at the position irradiated by the measuring light L1 emitted from the light radiating means 14.

Next, the measuring light L1 is radiated, and the mass spectrum of the reference sample S2 located at the point B1 is measured and stored in the data processor 28.

The data processor 28 removes the mass spectrum attributable to a substance other than the analyte M from the mass spectrum of the sample S1 using the mass spectrum of the reference sample S2 to calculate the mass spectrum of the analyte M and then the mass/charge number of ion of the analyte M.

Further, the drive mechanism moves the device 210 to locate the point A2 (Y coordinate 3) in the measuring region 212 at the position irradiated by the measuring light L1 emitted from the light radiating means 14.

Next, the measuring light L1 is radiated, and the mass spectrum of the sample S1 located at the point A2 is measured and stored in the data processor 28.

Then, the drive mechanism moves the device 210 to locate a point B2 (Y coordinate 3) in the reference region 214 at the position irradiated by the measuring light L1 emitted from the light radiating means 14.

Next, the measuring light L1 is radiated, and the mass spectrum of the reference sample S2 located at the point B2 is measured and stored in the data processor 28.

The data processor 28 removes the mass spectrum attributable to a substance other than the analyte M from the mass spectrum of the sample S1 using the mass spectrum of the reference sample S2 to calculate the mass spectrum of the analyte M and then the mass/charge number of ion of the analyte M.

The mass/charge number of ion of the analyte M may be both the mass/charge number of ion as detected at the points A1 and B1 and the mass/charge number of ion as detected at the points A2 and B2 or the average of these values.

As will be apparent from the above, the mass spectrum measured from the sample S1 placed at a given coordinate in the Y-axis direction in the measuring region 212 and the mass spectrum measured from the sample S2 placed at the same coordinate in the Y-axis direction in the reference region 214 are used to remove the mass spectrum attributable to a substance other than the analyte in order to detect the mass spectrum of the analyte.

Because the device 210 has consistent properties at any point on a line parallel to the X-axis, the emitted mass spectra of the substrate per se may be considered substantially equal at any point sharing an identical Y coordinate. Accordingly, even when a variation arises in a mass spectrum attributable to the substrate per se in the measuring region of the device 210 in the Y-axis direction, mass analysis of the analyte can be accomplished with a desirable measuring accuracy.

Sample holding devices as below may also be used as variations of the device 210.

One may use, for example, a device 310 as illustrated in FIG. 5 comprising on a substrate 311 two measuring regions 312a, 312b divided in a direction parallel to the X-axis and reference regions 314a, 314b placed alongside the measuring regions 312a, 312b, respectively. Thus, the device 310 has the reference region 314b, the measuring region 312b, the reference region 314a, and the measuring region 312a on the substrate 311 provided in this order from one end to the other of a line parallel to the X-axis.

Also with the device 310, one may likewise measure mass spectra from given points in the measuring regions and mass spectra from points in the adjacent reference regions having the same Y coordinates. Further, providing a plurality of measuring regions and the reference regions on a straight line parallel to the X-axis permits detection of mass spectra at a plurality of points having the same Y coordinates and different X coordinates. This enables detection of the mass/charge number of ion of the analyte taking account of variations of the substrate in the X-axis direction in addition to those in the Y-axis direction.

A device 410, another variation illustrated in FIG. 6, may also be used. The device 410 has measuring regions 412a to 412h divided in the X-axis and Y-axis directions and reference regions 414a to 414h likewise divided in the X-axis and Y-axis directions each formed for the respective measuring regions.

Using the device 410, the mass/charge number of ion of the analyte can be likewise detected according to the mass spectra measured from the measuring regions and mass spectra measured from the adjacent reference regions.

Since the mass spectra of a plurality of the neighboring reference regions placed adjacent the respective measuring regions in the X-axis direction can be used, the mass/charge number of ion of the analyte can be analyzed taking account of variations of the substrate in the X-axis direction in addition to those in the Y-axis direction.

Further, detection of mass spectra of different kinds of analytes can be readily accomplished because different analytes can be placed separately in the measuring regions.

Although the measuring region and the reference region are preferably arranged on a straight line normal to the first direction as described above when the substrate used is fabricated by rolling, injection, or other like process, the invention is not limited to that configuration.

It is also preferable that the sample holding device has a reference region lying on a straight line that passes through any point in the measuring region and is parallel to any one direction (major direction) on the surface and another reference region lying on a straight line that passes through said any point and is parallel to the direction (auxiliary direction) normal to said any one direction.

The above configuration of the sample holding device enables correction of the mass spectra detected in the measuring regions with two mass spectra (average thereof) detected in the reference regions each provided on two straight lines crossing each other at right angles.

This permits correction of variations occurring in the substrate in two directions and, hence, appropriate removal of the mass spectrum attributable to a substance other than the analyte, achieving detection of the mass/charge number of ion of the analyte with an increased accuracy.

Correction can be made taking account of variations in the substrate in the major and auxiliary directions, and a high-accuracy detection of the mass/charge number of ion of the analyte can be achieved by, for example, measuring a mass spectrum from a sample S1 placed at given coordinates in the measuring region, then measuring mass spectra from a reference sample S2 having the same coordinate in the major direction as said given coordinates and placed in the reference region and from a reference sample S2 having the same coordinate in the auxiliary direction as the given coordinates and placed in the reference region, followed by detecting the mass/charge number of ion of the analyte according to the mass spectrum measured from the sample S1 and the mass spectra measured from the sample S2 placed in a plurality of reference regions.

Now, description will be made in greater detail below by referring to specific examples.

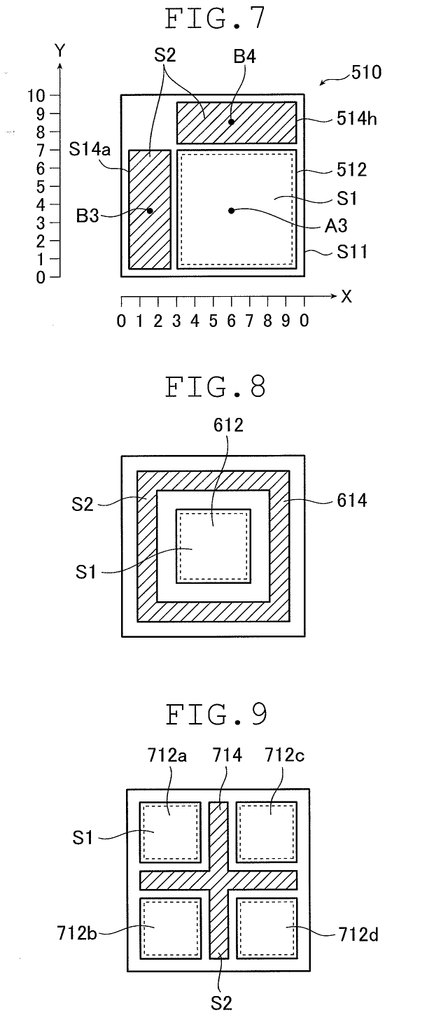

FIGS. 7, 8, and 9 are top plan views illustrating schematic configurations of other examples of the inventive sample holding device.

As illustrated in FIG. 7, a device 510 has provided on a substrate 511 a measuring region 512 carrying the sample S1 and two reference regions 514a, 514b carrying the reference sample S2.

The measuring region 512 is formed in a region meeting the conditions that it lies in a given range (Y coordinate 0.5 to 7) in the major direction (Y-axis direction in FIG. 7) of the substrate 511 and also in a given range (X coordinate 3 to 9.5) in the auxiliary direction (X-axis direction in FIG. 7) of the substrate 511. The reference region 514a is formed in a given region (Y coordinate 0.5 to 7) in the Y-axis direction; the reference region 514b is formed in a given region (X coordinate 3 to 9.5) in the X-axis direction.

Description will now be made of the operation of the device illustrated in FIG. 7, by way of example, where the mass spectrum of the sample S1 is detected at a point A3 in the measuring region 512 to detect the mass/charge number of ion of the analyte M.

First, the drive mechanism moves-the device 510 to locate the point A3 (Y coordinate 4, X coordinate 6) in the measuring region 512 at the position irradiated by the measuring light L1.

Then, the measuring light L1 is radiated, and the mass spectrum of the sample S1 disposed at the point. A3 is measured and stored in the data processor 28.

Next, the drive mechanism moves the device 510 to locate a point B3 (Y coordinate 4) in the reference region 514a at the position irradiated by the measuring light L1.

Then, the measuring light L1 is radiated, and the mass spectrum of the sample S2 disposed at the point B3 is measured and stored in the data processor 28.

Further, the drive mechanism moves the device 510 to locate a point B4 (X coordinate 6) in the reference region 514b at the position irradiated by the measuring light L1.

Then, the measuring light L1 is radiated, and the mass spectrum of the sample S2 disposed at the point B4 is measured and stored in the data processor 28.

Subsequently, the average of the mass spectrum detected at the point B3 and the mass spectrum detected at the point B4 is worked out as the mass spectrum of the reference sample S2.

The data processor 28 uses the mass spectrum of the reference sample S2 calculated as an average to remove the mass spectrum attributable to a substance other than the analyte M to work out the mass spectrum of the analyte M and the mass/charge number of ion of the analyte M.

As will be apparent from the foregoing, the mass/charge number of ion of the analyte M can be detected taking into account the variations in the substrate in the Y-axis direction in the measuring region 512 of the device 510 and the variations in the substrate in the X-axis direction and, hence, the mass/charge number of ion of the analyte M can be detected with an increased measuring accuracy. This is achieved by detecting the mass/charge number of ion of the analyte M using the mass spectrum measured from the sample S1 placed at given coordinates (the point A3) in the measuring region 512, the mass spectrum measured from the reference sample S2 placed at a position (the point B3) in the measuring region 514a and having the same Y coordinate as the point at said given coordinates, and the mass spectrum measured from the reference sample S2 placed at a position (the point B4) in the measuring region 514b having the same X coordinate as the point at said given coordinates.

Sample holding devices as below may be used as variations of the device 510.

One may use, for example, a device 610 as illustrated in FIG. 8 comprising on a substrate 611 a measuring region 612 and a reference region 614 surrounding the periphery of the measuring region 612.

Alternatively, one may use a device 710 as illustrated in FIG. 9 comprising on a surface 711 a cross-shaped reference region 714 and measuring regions 712a to 712d divided by the reference region 714.

Alternatively, reference regions in the form of a mesh may be formed on a substrate. In this case, the mass/charge number of ion of the analyte M may be detected using the average of the mass spectrum measured from a measuring region, the mass spectrum measured from a reference region having the same Y coordinate as and located closest to the measuring point, and the mass spectrum measured from a reference region having the same X coordinate as and located closest to the measuring point.

Instead of measuring mass spectra from reference regions lying in both Y-axis and X-axis directions, one may measure a mass spectrum from a reference region in close proximity and use the intensity of that mass spectrum to make corrections.

Although the mass spectra of the measuring regions and the reference regions are measured alternately in the above embodiments, the invention is not limited this way. One may, for example, measure and store mass spectra of all the pertinent points in the reference regions and then measure mass spectrum in the measuring region in order to detect the mass spectrum of the analyte.

Further, the mass spectra of the reference regions may be detected after the spectrum of the measuring region is detected or, conversely, the mass spectrum of the measuring region may be detected after the spectra of the reference regions are detected.

Although the above embodiments all illustrate cases where the invention is applied to the mass spectroscope of MALDI type whereby the sample S1 and the reference sample S2 each contain a matrix whereas the sample S1 is placed in the measuring region and the reference sample S2 is placed in the reference region, the invention is not limited this way. The invention may be applied, for example, to the mass spectroscope of SALDI type.

The mass spectroscope and the sample holding device of SALDI type basically have the same configurations as the mass spectroscope 10 of FIGS. 1A and 1B and the device 12 of FIG. 2 except that the samples do not contain the matrix and that a microstructure is provided in the measuring region and the reference region.

Like the device 12, the sample holding device of SALDI type comprises a substrate and a measuring region and a reference region on the substrate.

The measuring region and the reference region of the sample holding device of this embodiment have the same configuration except that the measuring region has an analyte placed thereon and the reference region does not have any analyte placed thereon. In other words, when using the sample holding device according to this embodiment, a sample is placed in the measuring region as an analyte while the reference region has the same configuration as the measuring region except that the reference sample is not placed in the reference region, and hence the analyte is not placed therein.

The measuring region and the reference region each have a microstructure 29 that generates an enhanced field upon irradiation by measuring light.

Now, the microstructure 29 will be described below.

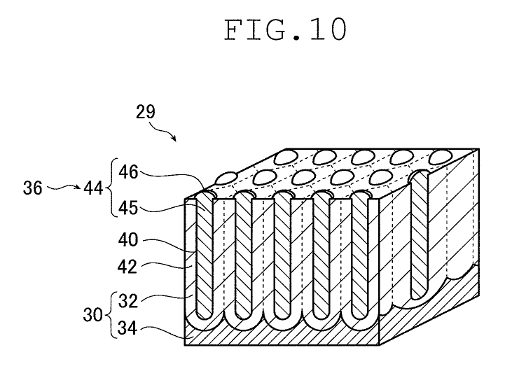

FIG. 10 is a perspective view of a schematic configuration of the microstructure 29 to be placed in the measuring region and the reference region.

As illustrated in FIG. 10, the microstructure 29 comprises a substrate 30 and metallic members 36. The substrate 30 comprises a dielectric base 32 and an electric conductor 34 disposed on one surface of the dielectric base 32. The metallic members 36 are disposed in the surface of the dielectric base 32 opposite from the electric conductor 34.

The substrate 30 comprises the dielectric base 32 formed of a metallic oxide (Al₂O₃) and the electric conductor 34 disposed on the one surface of the dielectric base 32 and formed of a non-anodized metal (Al). The dielectric base 32 and the electric conductor 34 are formed integrally.

The dielectric base 32 has micropores 40 each having the shape of a substantially straight tubing that extends from the surface opposite from the electric conductor 34 toward the surface closer to the electric conductor 34.

Each of the micropores 40 extends through the dielectric base 32 so as to form an opening on one end thereof in the surface opposite from the electric conductor 34, with the other end closer to the electric conductor 34 closing short of the surface of the dielectric base 32. In other words, the micropores 40 do not reach the electric conductor 34. The micropores 40 each have a diameter smaller than the wavelength of the excitation light and are arranged regularly at a pitch that is smaller than the wavelength of the excitation light.

When the excitation light used is a visible light, the micropores 40 are preferably arranged at a pitch of 200 nm or less.

The metallic members 36 are formed of rods 44 each having a filler portion 45 and a projection (bulge) 46 above each micropore. The filler portion 45 fills the inside of each micropore 40 of the dielectric base 32. The projection 46 sticks out from the surface of the dielectric base 32 and has an outer diameter greater than that of the filler portion 45. The material for forming the metallic members 36 may be selected from various metals capable of generating localized plasmons and include, for example, Au, Ag, Cu, Al, Pt, Ni, Ti, and an alloyed metal thereof. Alternatively, the metallic members 36 may contain two or more of these metals. To obtain a further enhanced field effect, the metallic members 36 are more preferably formed using Au or Ag.

The microstructure 29 has a configuration as described above such that the surface on which the projections 46 of the rods 44 of the metallic members 36 are arranged is the surface irradiated by the measuring light.

Now, the method of producing the microstructure 29 will be described.

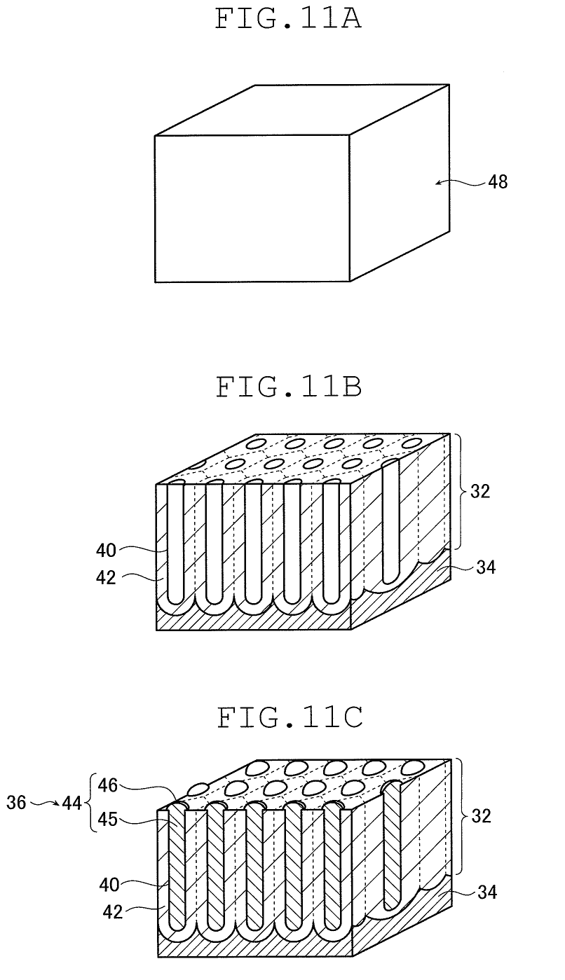

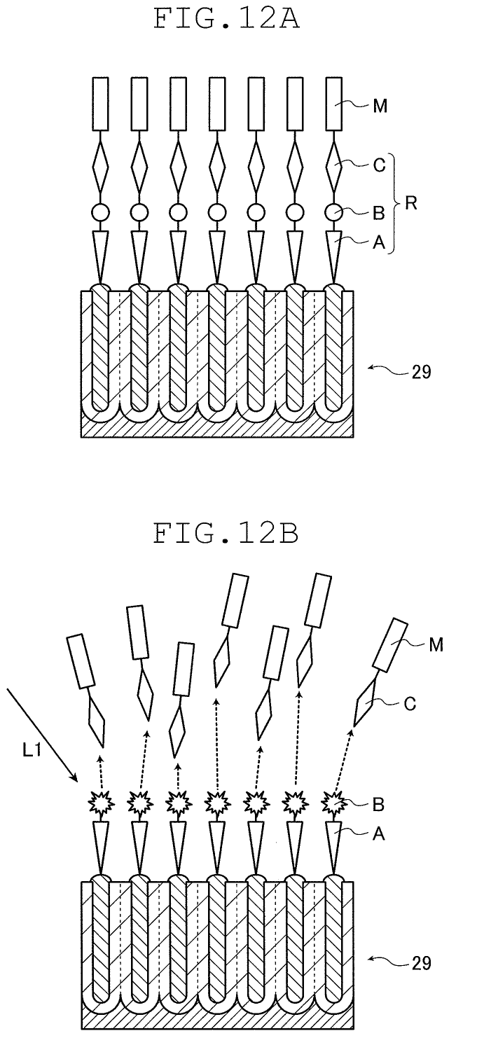

FIGS. 11A to 11C illustrate an example of the process for producing the microstructure 29.

First, a metallic body 48 to be anodized having the shape of a rectangular solid as illustrated in FIG. 11A is anodized. Specifically, the metallic body 48 to be anodized is immersed in an electrolytic solution as an anode together with a cathode, whereupon an electric voltage is applied between the anode and the cathode to achieve anodization.

The cathode may be formed, for example, of carbon or aluminum. The electrolytic solution is not limited specifically; preferably used is an acid electrolytic solution containing at least one of sulfuric acid, phosphoric acid, chromic acid, oxalic acid, sulfamic acid, benzenesulfonic acid and amidosulfonic acid.

Although the metallic body 48 to be anodized has the shape of a rectangular solid in this embodiment, the shape is not limited thereto and may vary. Further, one may use a configuration comprising a support member on which, for example, a layer of the metallic body 48 to be anodized is formed.

Anodization of the metallic body 48 causes oxidation to take place as illustrated in FIG. 11B from the surface of the metallic body 48 to be anodized in a direction substantially vertical to that surface, producing a metallic oxide (Al₂O₃), which is used as the dielectric base 32. The metallic oxide produced by anodization or the dielectric base 32 has a structure wherein numerous minute columns 42 each having a substantially hexagonal shape in planar view are arranged leaving no space between them.

The minute columns 42 each have a round bottom and a micropore 40 formed substantially at the center and extending straight from the top surface in the depth direction, i.e., in the direction of the axis of the minute columns 42. For the structure of a metallic oxide produced by anodization, reference may be had, for example, to “Production of Mesoporous Alumina by Anodizing Method and Applications Thereof as Functional Material” by Hideki Masuda, page 34, Zairyo Gijutsu (Material Technology), Vol. 15, No. 10, 1997.

An example of preferred anodization conditions for producing a metal oxide having a regularly arrayed structure includes an electrolytic solution having a concentration of 0.5 M, a liquid temperature in the range of 14° C. to 16° C., and an applied electric voltage of 40 V to 40 V±0.5 V among other conditions when using oxalic acid as an electrolytic solution. The micropores 40 produced under these conditions each have, for example, a diameter of about 30 nm and are arranged at a pitch of about 100 nm.

Next, the micropores 40 of the dielectric base 32 are electroplated to form the rods 44 each having the filler portion 45 and the projection 46 as illustrated in FIG. 11C.

In the electroplating, the electric conductor 34 acts as an electrode, causing a metal to be deposited preferentially from the bottoms of the micropores 40 where the electric field is stronger. Continued electroplating causes the micropores 40 to be filled with a metal, forming the filler portions 45 of the rods 44. Electroplating further continued after the formation of the filler portions 45 causes the metal to overflow from the micropores 40. However, the electric field near the micropores 40 is so strong that the metal continues to be deposited around the micropores 40 until the metal is deposited above the filler portions 45 so as to bulge from the surface of the dielectric base 32, thus forming the projections 46 having a diameter greater than that of the filler portions 45.

This is how the microstructure 29 is produced.

Now, mass spectroscopic method using the mass spectroscope according to this embodiment will be described.

First, the analyte M (sample) is placed in the measuring region of the sample holding device, and then the sample holding device is placed on the support 13a of the device moving means 13.

Thereafter, the moving mechanism 13b of the device moving means 13 moves the sample holding device to locate the measuring region 21 at the position irradiated by the light emitted by the light radiating means 14.

Subsequently, the voltage Vs is applied to the sample holding device, and the measuring light L1 is emitted by the light radiating means 14 in response to a given start signal to irradiate the measuring region 21 of the sample holding device with the measuring light L1.

The irradiation by the measuring light L1 causes an enhanced field associated with localized plasmons to be generated at the surface of the microstructure disposed in the measuring region. The analyte M is desorbed from the measuring region by the optical energy of the measuring light L1 intensified by the enhanced field.

The desorbed analyte M reaches the detector 26 and is thereby detected as in the mass spectroscope 10. Further, a mass spectrum is calculated according to the detection results. Note that substances present on the substrate other than the analyte M are also desorbed and therefore detected.

When the detection of the mass spectrum of the sample in the measuring region is accomplished, the drive mechanism 13b of the device moving means 13 moves the device 12 to locate the reference region at the position irradiated by the light emitted by the light radiating means 14.

Then, the reference region is irradiated by the measuring light L1 as in the case where the sample in the measuring region is detected.

Although no sample is placed in the reference region 22, the substance in the reference region 22 is desorbed because an enhanced field is generated at the surface of the microstructure. The desorbed substance is detected by the detector 26, and the mass spectrum of the reference region is calculated according to the relationship between the detection results and the time of flight.

Next, the mass spectrum of the analyte M is calculated according to the mass spectrum detected from the measuring region and the mass spectrum detected from the reference region.

Specifically, the mass spectrum of the analyte M is calculated by removing from the mass spectrum of the measuring region the mass spectrum detected from the reference region having the same configuration as the measuring region except that the reference region does not contain the analyte M (i.e., by detecting the difference).

Thus, the mass spectroscope according to the embodiment under discussion analyzes the mass/charge number of ion of the analyte M (or detects the mass distribution).

Thus, in the above embodiments where the invention is applied to the mass spectroscope using the SALDI method, the measuring region and the reference region having the same configuration as the measuring region except that the reference region has no analyte placed thereon are formed on the sample holding device, and the mass spectrum measured from the reference region is removed from the mass spectrum measured from the measuring region to achieve detection of the analyte M with a high accuracy, producing the same effects as where the mass spectroscope 10 is used.

The sample holding device using the SALDI method, for example a sample holding device comprising metallic members forming a corrugated surface structure on the substrate, may have variations in the degree of intensity of the enhanced field within the region of the metallic members that develop when the metallic members having a corrugated structure are formed. As a result, variations may be produced in the measurements obtained depending upon from which point in the measuring region the mass spectrum is measured.

When the measuring region lies in a given range in the first direction of the surface of the sample holding device (i.e., in a given coordinate range), therefore, the reference region also is preferably so provided as to contain the given range in the first direction, as earlier described, in the sample holding device according to this embodiment as well.

It is also preferable that the sample holding device has a reference region lying on a straight line that passes through any point in the measuring region and is parallel to any one direction (major direction) on the surface and, additionally, another reference region lying on a straight line that passes through said any point and is parallel to the direction (auxiliary direction) normal to said any one direction.

The above arrangement of the measuring region and the reference region on the sample holding device enables detection of the analyte with an increased accuracy regardless of variations that lie in the substrate and the microstructure.

Preferably, the device 12 is surface-modified (provided with trapping members) so that it can trap the analyte and allows the analyte to desorb from the surface of the device upon irradiation with the measuring light in both the mass spectroscope 10 and the mass spectroscope 100.

When the analyte is an antigen, for example, the amount of the analyte attached to the surface of the microstructure can be increased and the sensitivity with which the mass analysis measurement is made can be improved by modifying the surface of the microstructure with an antibody that binds specifically to the antigen.

FIG. 12A is a sectional view illustrating a schematic configuration of a surface-modified microstructure; FIG. 12B is a sectional view illustrating a state where an analyte is desorbed from the microstructure illustrated in FIG. 12A. FIGS. 12A and 12B illustrate a surface modification R and its components on an enlarged scale for easy recognition.

On the surface of a microstructure 29, a surface modification R comprises first linker function units A that bind to the surface of the microstructure 29, second linker function units C that bind to the analyte M, and decomposing function units B that are disposed between the first linker function units A and the second function units C and decomposed by an electric field generated by the irradiation with the measuring light, as illustrated in FIG. 12A. In the illustrated example, the analyte M is disposed close to the measuring region of the sample holding device through the intermediary of the surface modification R.

The surface modification R may be a single substance comprising all of the first linker function units A, the second linker function units C, and the decomposing function units B. Alternatively, these units may be different substances. Alternatively, the first linker function units A and the decomposing function units B may be one substance or the decomposing function units B and the second linker function units C may be one substance.

When the device 12 is irradiated by the measuring light L1, localized plasmons are generated on the surface of the microstructure to create enhanced fields on the surface of the measuring region. The optical energy of the measuring light L1 is enhanced near the surface by the enhanced fields generated at the surface of the measuring region.

As illustrated in FIG. 12B, the enhanced energy causes the decomposition of the decomposing function units B of the surface modification, desorbing the analyte M and the second linker function units C bound to the analyte M from the surface of the measuring region.

Thus, the analyte can be desorbed from the surface of the microstructure by using the surface modification.

Further, because the analyte M is bound to the microstructure 29 through the intermediary of the surface modification, the analyte M can be located apart from the measuring region or the surface of the microstructure.

The enhanced field effect produced at the surface of the microstructure is the one caused by near-field light that is in turn produced by localized plasmons and, hence, decreases exponentially with respect to the distance from the surface. Accordingly, with the analyte M positioned relatively away from the surface as illustrated in FIG. 12A, the field enhancement has a minimized effect upon the optical energy of the measuring light L1 with which the analyte M is irradiated. Thus, the damage to the analyte M caused by the intensified optical energy can be reduced so that a high-accuracy mass analysis can be achieved.

The configuration of the microstructure is not limited to that of the microstructure 29 and may vary, provided that it comprises projections having dimensions permitting excitation of localized plasmons on the substrate.

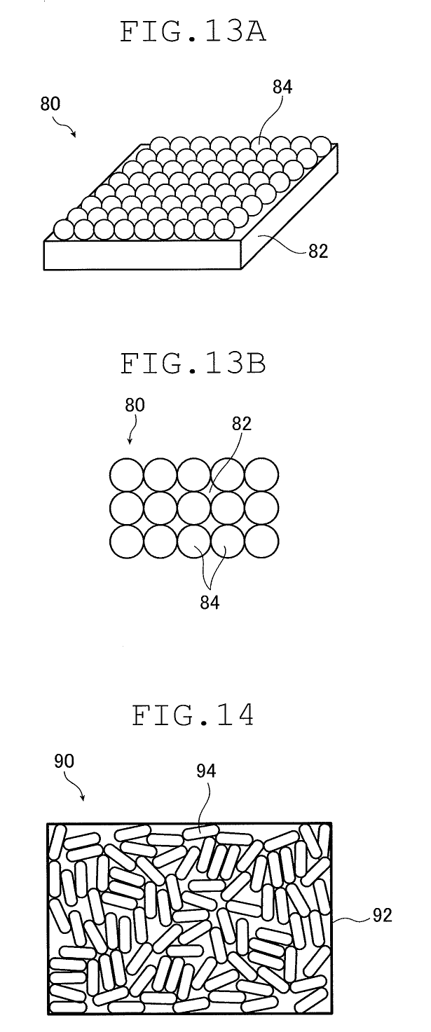

FIG. 13A is a perspective view illustrating a schematic configuration of another example of the microstructure; FIG. 13B is a top plan view of FIG. 13A.

A microstructure 80 illustrated in FIGS. 13A and 13B comprises a substrate 82 and numerous metallic particles 84 disposed on the substrate 82.

The substrate 82 is a base material in the form of a plate. The substrate 82 may be formed of a material capable of supporting the metallic particles 84 in an electrically insulated state. The material thereof is exemplified by silicon, glass, yttrium-stabilized zirconia (YSZ), sapphire, and silicon carbide.

The numerous metallic particles 84 are each of dimensions permitting excitation of localized plasmons and held in position so that they are spread on one surface of the substrate 82.

The metallic particles 84 may be formed of any of the metals cited above for the metallic members 36. Further, the metallic particles 84 may be formed of the same metal as or a different metal from the one used to form the metallic particles described earlier. The shape of the metallic particles is not limited specifically; it may be, for example, a sphere or a rectangular solid.

The microstructure 80 having such a configuration can also generate localized plasmons around the metallic particles and, hence, an enhanced electric field when the detection surface on which the metallic particles are disposed is irradiated by the excitation light.

FIG. 14 is a top plan view illustrating a schematic configuration of another example of the microstructure.

A microstructure 90 illustrated in FIG. 14 comprises a substrate 92 and numerous metallic nanorods 94 disposed on the substrate 92.

The substrate 92 has substantially the same configuration as the substrate 82 described earlier, and therefore a detailed description thereof will not be given here.

The metallic nanorods 94 are metallic nanoparticles each having dimensions permitting excitation of localized plasmons and each shaped like a rod having the minor axis and the major axis different in length from each other. The metallic nanorods 94 are secured so that they are fixedly disposed on one surface of the substrate 92. The metallic nanorods 94 has a major axis that is smaller than the wavelength of the excitation light. The metallic nanorods 94 may be formed of the same metal as the metallic particles described above. For details of the configuration of metallic nanorods, reference may be had, for example, to JP 2007-139612 A.

The microstructure 90 may be produced by the same method as described above for the microstructure 80.

The microstructure 90 having such a configuration can also create an enhanced electric field when the detection surface on which the metallic nanorods are disposed are irradiated by the excitation light.

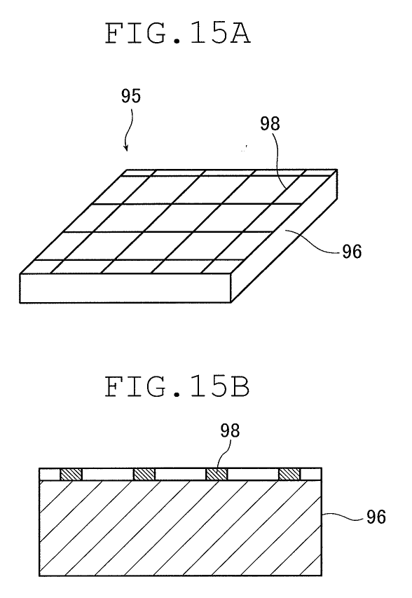

Now, reference is made to FIG. 15A, which is a perspective view illustrating a schematic configuration of another example of the microstructure; FIG. 15B is a sectional view of FIG. 15A.

A microstructure 95 illustrated in FIG. 15 comprises a substrate 96 and numerous thin metallic wires 98 provided on the substrate 96.

The substrate 96 has substantially the same configuration as the substrate 82 described earlier, and therefore detailed description thereof will not be given here.

The thin metallic wires 98 are linear members each having a line width permitting excitation of localized plasmons and arranged like a grid on one surface of the substrate 96. The thin metallic wires 98 may be formed of the same metal as the metallic particles and the metallic members described earlier. The thin metallic wires 98 may be produced by any of various methods used to produce metallic wiring including but not limited to vapor deposition and plating.

Specifically, the line width of the thin metallic wires 98 is preferably 50 nm or less, and preferably 30 nm or less. The thin metallic wires 98 may be arranged in any pattern including but not limited to a pattern where the thin metal wires do not cross each other, i.e., are parallel to each other. The thin metallic wires 98 are also not limited in shape to straight lines and may be curved lines.

Thus, an enhanced electric field can be generated by localized plasmons also in the microstructure 95 having such a configuration when the detection surface on which the thin metallic wires are arranged is irradiated by the excitation light.

Further, the microstructure is not limited to the microstructure 29, the microstructure 80, the microstructure 90, or the microstructure 95; the microstructure may have a configuration comprising projections from these microstructures capable of exciting localized plasmons.

Note that the embodiments of the mass spectroscope of the invention described above in detail are only illustrative and not restrictive of the invention and that various improvements and modifications may be made without departing from the spirit of the invention.

For example, although the mass spectroscope 10 has been described taking, by way of example, a system that performs mass analysis using the TOF-MS method (time of flight mass spectroscopy), the invention is not limited to such an application and may be used for various other systems whereby an analyte placed on the surface of the sample holding device is desorbed and detected. For example, the invention may also be applied to quadrupole mass spectrometers, ion trap mass spectrometers, magnetic sector-type mass spectrometers, and FT-ICR mass spectrometers.

Although the above embodiments have been described taking for example cases using the MALDI method and the SALDI method whereby the detection surface is irradiated by light to ionize the analyte, the invention is not limited this way. The invention may also be applied to a method such as, for example, the fast atom bombardment method whereby the analyte is irradiated by ion beams and thereby ionized.

What is claimed is:

1. A sample holding device used for a mass spectroscope for irradiating a detection surface with light or ion beam to ionize an analyte sample placed upon the detection surface and desorb the analyte sample from the detection surface and detecting a mass/charge number of ion of the ionized analyte, the sample holding device comprising:
a substrate on which the detection surface is formed,
a measuring region that is formed on the detection surface of the substrate and on which at least an analyte is placed, and
a reference region that is formed in another region of the detection surface of the substrate except for the measuring region, the reference region having a same configuration as the measuring region except that the reference region does not have the analyte placed thereon.

2. The sample holding device according to claim 1, comprising a microstructure disposed in each of the measuring region and the reference region, the microstructure being capable of exciting localized plasmons upon irradiation by light.

3. The sample holding device according to claim 1, wherein a sample containing the analyte is placed in the measuring region and a sample not containing the analyte is placed in the reference region.

4. The sample holding device according to claim 1, wherein a sample containing the analyte and a matrix is placed in the measuring region and a sample not containing the analyte but containing the matrix is placed in the reference region.

5. The sample holding device according to claim 1, wherein the reference region is formed in a region containing a straight line passing through the measuring region and parallel to a direction in which the substrate is rolled or injected when manufactured.

6. The sample holding device according to claim 1, wherein the reference region is formed in at least two regions each containing one of two straight lines.:passing through any point in the measuring region and crossing each other at right angles.

7. A mass spectroscope comprising:
the sample holding device having a measuring region and a reference region according to claim 1,
radiating means for irradiating the sample holding device with light or ion beam,
ion detecting means for detecting ions emitted from the measuring region of the sample holding device and ions emitted from the reference region of the sample holding device,
mass spectrum calculating means for calculating a first mass spectrum according to detection results of the ions emitted from the measuring region and calculating a second mass spectrum according to detection results of the ions emitted from the reference region,
mass spectrum correcting means for correcting the first mass spectrum according to the second mass spectrum calculated by the mass spectrum calculating means, and
mass detecting means for detecting a mass/charge number of ion of the analyte according to a value corrected by the mass spectrum correcting means.

8. The mass spectroscope according to claim 7, further comprising moving means for moving the sample holding device in a direction parallel to a line connecting the measuring region and the reference region.

9. The mass spectroscope according to claim 7, wherein the radiating means is a light emitting mechanism capable of emitting a plurality of light beams different in at least one of intensity and wavelength to irradiate the sample holding device with light by switching at least one of intensities or wavelengths of the light emitted from the light emitting mechanism.

10. A mass spectroscopic method comprising:
a first mass spectrum detecting step of irradiating a measuring region of the mass spectrum device according to claim 1 with light or ion beam to detect ions emitted from the measuring region and calculating a first mass spectrum from detection results,
a second mass spectrum detecting step of irradiating a reference region of the mass spectrum device with light or ion beam to detect ions emitted from the reference region and calculating a second mass spectrum from detection results,
a correcting step of correcting the first mass spectrum using the second mass spectrum, and
a mass detecting step of detecting a mass/charge number of ion of the analyte according to correction results obtained in the correcting step.

11. The mass spectroscopic method according to claim 10, wherein the second mass spectrum is detected in the second mass spectrum detecting step after the first mass spectrum is detected in the first mass spectrum detecting step.

12. The mass spectroscopic method according to claim 10, wherein the first mass spectrum is detected in the first mass spectrum detecting step after the second mass spectrum is detected in the second mass spectrum detecting step.
